(19) United States
(12) Patent Application Publication
(10) Pub. No.: US 2011/0128687 A1
(43) Pub. Date: Jun. 2, 2011

(54) COMPUTER SYSTEM

(75) Inventors: XIAO-ZHU CHEN, Shenzhen City (CN); RONG HU, Shenzhen City (CN)

(73) Assignees: HONG FU JIN PRECISION (ShenZhen) Co., LTD., Shenzhen City (TW); HON HAI PRECISION INDUSTRY CO., LTD., Tu-Cheng (TW)

(21) Appl. No.: 12/730,237

(22) Filed: Mar. 24, 2010

(30) Foreign Application Priority Data
Nov. 27, 2009 (CN) 200910310574.8

(51) Int. Cl. G06F 1/16

(52) U.S. Cl. 361/679.02

(57) ABSTRACT

A computer system includes an enclosure defining a window, a cover pivotably attached to the enclosure, a bracket fixed to a bottom of the cover, a pair of rails fixed to a bottom of the bracket and a hard disk slidably retained between the two rails. The cover can be pivoted to an opened position to bring the hard disk to a place out of the enclosure where the hard disk is accessible. The cover can be further pivoted to a closed position to cover the window to thereby receive the hard disk within the enclosure.

### BACKGROUND

1. Technical Field

The present disclosure relates to computer systems and, more particularly, to a computer system having a structure allowing convenient replacement of electronic elements thereof.

2. Description of Related Art

Computers are generally densely packed with electronic components to save space. Unfortunately, besides saving space, the density of the components make it difficult to service parts inside the computer. In order to replace electronic components received in the computers, the enclosures of the computers have to be wholly disassembled to gain access to the components to be replaced.

What is needed, therefore, is a computer system which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a computer system of this disclosure, wherein a supportive element of the computer system is in a closed position.

FIG. 2 is an exploded view of FIG. 1.

FIG. 3 is a further exploded view of a part of FIG. 2.

FIG. 4 is an inverted view of FIG. 3.

FIG. 5 is similar to FIG. 1, wherein the supportive element is in an opened position.

### DETAILED DESCRIPTION

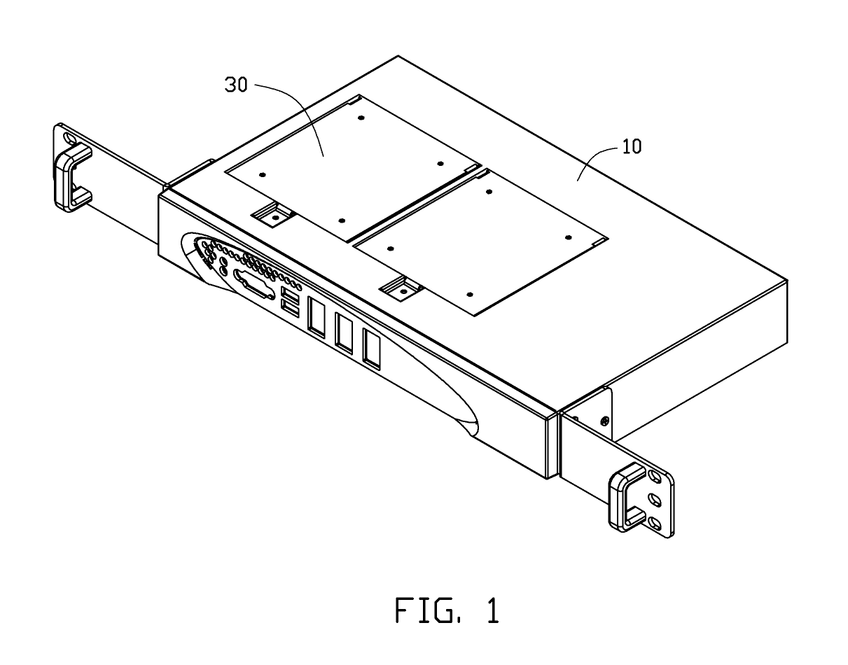

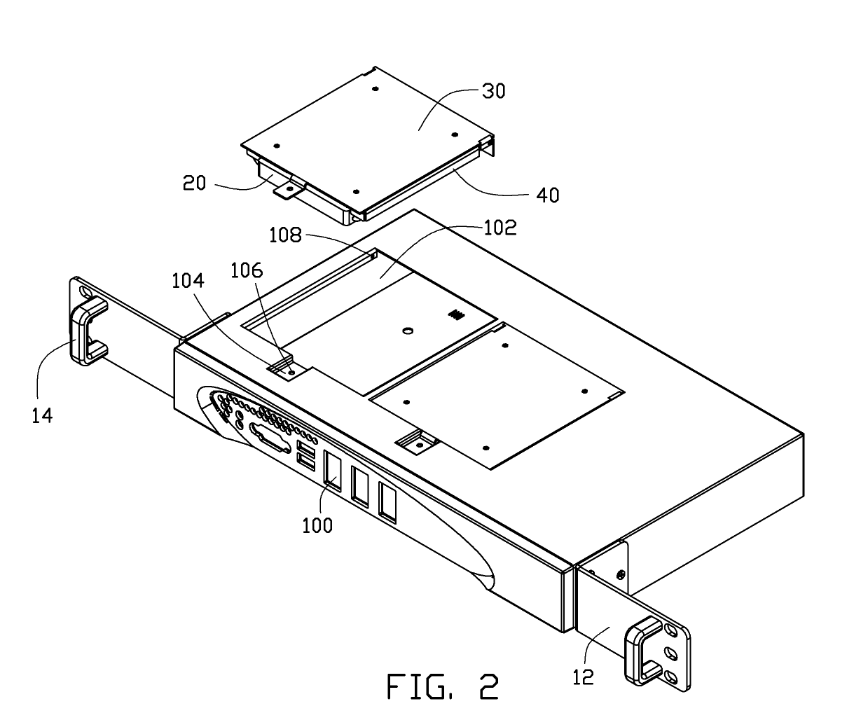

Referring to FIGS. 1-2, a computer system of the present disclosure is disclosed. The computer system includes an enclosure 10, a supportive element pivotably attached on the enclosure 10 and multiple hard disks 20 retained in the enclosure 10 by the supportive element.

The enclosure 10 has two arms 12 fixed on two opposite lateral sides thereof, respectively. The enclosure 10 defines a plurality of openings 100 in a front thereof for exposing connecting ports in the enclosure 10. Each arm 12 has an end fixed to the enclosure 10, and an opposite end perpendicular to the end and remote from the enclosure 10. A handle 14 is formed on the end of each arm 12 remote from the enclosure 10 for facilitating transportation of the computer system. Two rectangular windows 102 (only one is described below for brevity) are defined in a top of the enclosure 10 for receive the hard disks 20 in the enclosure 10. The top of the enclosure 10 further has a recess 104 defined neighboring the window 102. A threaded hole 106 is defined in a bottom of the recess 104. A pair of pivoting holes 108 (only one shown in FIG. 2) is defined in an interior of the enclosure 10 and adjacent to two opposite sides of the window 102.

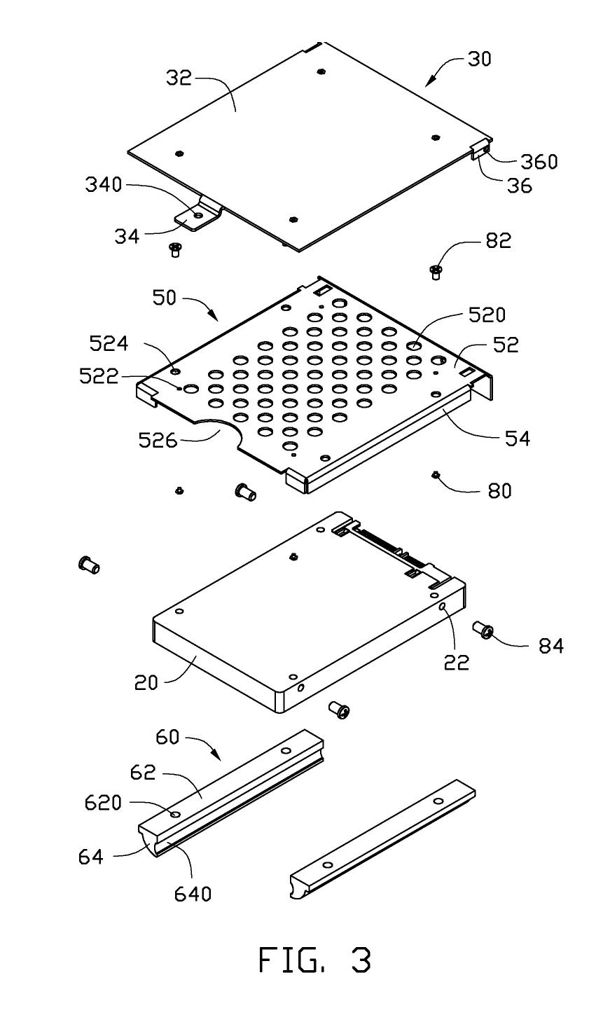

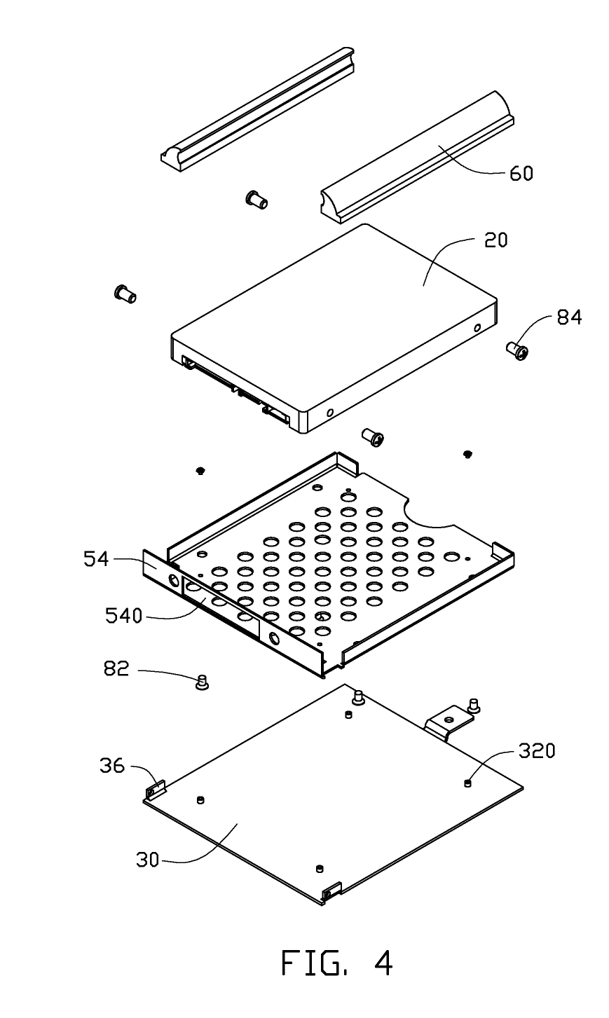

Also referring to FIGS. 3-4, the supportive element includes a cover 30 pivotably attached to the enclosure 10, a bracket 50 fixed on a bottom of the cover 30, and a pair of rails 60 secured on a bottom of the bracket 50. The cover 30 includes a rectangular plate 32, a tongue 34 extending parallelly away from, but offset to, one edge of the plate 32, a pair of tabs 36 extending perpendicularly away from two opposite lateral edges of the plate 32 towards an interior of the enclosure 10. The plate 32 has four small seats 320 formed extending from adjacent four corners of an interior side thereof, respectively (shown in FIG. 4). The plate 32 has an area similar to that of the window 102 in the enclosure 10 so that the plate 32 can substantially cover the window 102. The tongue 34 is for being received in the recess 104 for positioning the cover 30 on the enclosure 10. The tongue 34 has a through hole 340 defined in a center thereof corresponding to the threaded hole 106 in the recess 104 of the enclosure 10. A screw can extend through the through hole 340 in the tongue 34 into the through hole 106 in the recess 104 so as to fix the tongue 34 in the recess 104. Each tab 36 has an aperture 360 in line with the pivoting holes 108 in the enclosure 10. A fastener can extend through the aperture 360 of the tab 36 into a neighboring pivoting hole 108 to pivotably mount the cover 30 on the enclosure 10.

The bracket 50 includes a sheet 52 and a plurality of flanges 54 extending perpendicularly from a periphery of the sheet 52. The sheet 52 defines a matrix of circular holes 520 in a central area thereof for reducing a weight of the bracket 50. Four bores 522 are defined near four corners of a profile of the plurality of circular holes 520, respectively. Screws 80 can extend through the four bores 522 in the sheet 52 into the seats 320 of the cover 30, thereby securing the bracket 50 on the cover 30. Four fixing holes 524 are defined near four corners of the sheet 52, respectively. The flanges 54 are mainly distributed at two lateral sides and a rear side of the sheet 52, wherein the flange 54 at the rear side of the sheet 52 defines a rectangular slot 540 in a central area thereof, the flanges 54 at the lateral sides of the sheet 52 are spaced from the flange 54 at the rear side of the sheet 52 by two gaps for receiving the tabs 36 of the cover 30, the flanges 54 at a front side of the sheet 52 are spaced from each other for leaving an entrance/exit for the hard disk 20 into/out of the bracket 50. The flanges 54 are for confining the rails 60 to thereby facilitate positioning of the rails 60 on the bracket 50. A curved cutout 526 is defined in the front side of the sheet 52 between two corresponding flanges 54.

The two rails 60 are respectively fixed on the bottom of the sheet 52 at the two lateral sides of the sheet 52. Each rail 60 includes a rectangular beam 62 and an elongated hook 64 extending curvedly from a bottom of the beam 62. Two mounting holes 620 are defined in a top of the beam 62 corresponding to the fixing holes 524 in the bracket 50. Screws 82 can extend through the fixing holes 524 in the bracket 50 into the mounting holes 620 of the rails 60, thereby securing the rails 60 on the bracket 50. A groove 640 is confined by an inner face of the hook 64 for allowing the hard disk 20 slidable therein.

The hard disk 20 is rectangular and defines four securing holes 22 in two opposite sides thereof. Screws 84 are extended into the securing holes 22 in the hard disk 20. Nuts of the screws 84 have diameters slightly less than width of the groove 640 so that the nuts of the screws 84 can be received in the grooves 640 for providing supportive points to the hard disk 20.

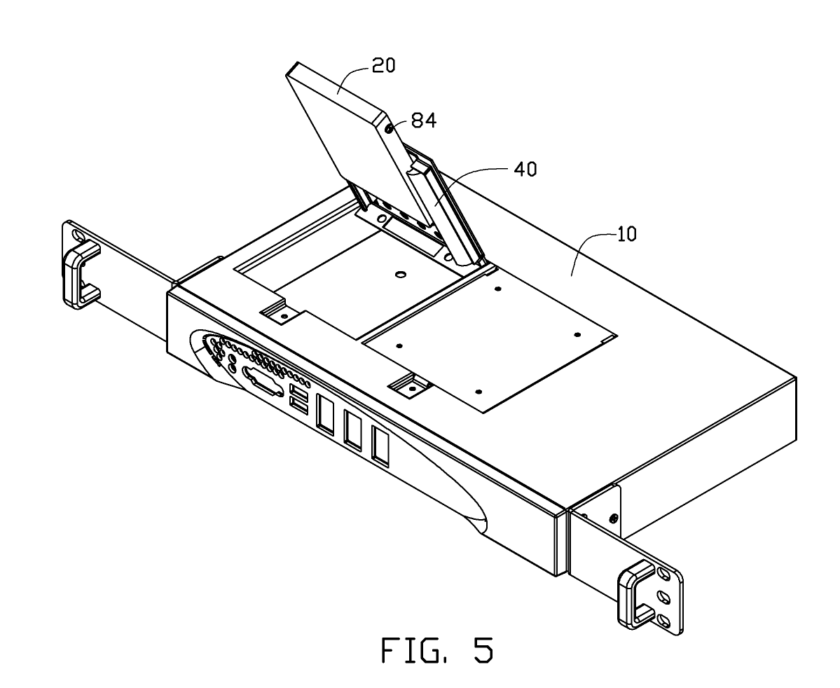

Also referring to FIG. 5, when the hard disk 20 received in the enclosure 10 is required to be replaced, a user only needs to pivot the cover 30 from the window 102 to an open position where the supportive element and the hard disk 20 retained therein are oriented towards an inclined direction, then pull the hard disk 20 slidably from the bracket 50 along the rails 60. Therefore, the hard disk 20 is conveniently detached from the enclosure 10. A new hard disk 20 can be pushed into the hollow bracket 50 along the rails 60, and then rotated within the enclosure 10 by pivoting the cover 30 to a closed position where the window 102 of the enclosure 10 is substantially covered by the cover 30.

Note that the bracket 50 is manufactured to have a thickness that may prevent resonance when the hard disk 20 is in operation. Alternatively, the bracket 50 can also be omitted if the cover 30 is designed to have the same functionality as the bracket 50, then the two rails 60 can be directly fixed to the bottom of the cover 30. Furthermore, the hard disk 20 referred above is only one preferred example, other type electronic components required to be conveniently replaced, can also be used with the computer system of the present disclosure.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A computer system comprising:
an enclosure defining a window;
a cover pivotably attached to the enclosure and covering the window;
a pair of rails fixed to the cover; and
an electronic component slidably retained between the pair of rails;
wherein the cover is pivotable remotely from the window to bring the electronic component exposing out of the enclosure.

2. The computer system as claimed in claim 1, wherein the pair of rails define two grooves facing each other, respectively.

3. The computer system as claimed in claim 2, wherein each of the rails comprises a beam mounted to the cover and a hook extending from the beam, the groove being defined by the hook.

4. The computer system as claimed in claim 3, wherein the electronic component has a plurality of fasteners fixed on two opposite sides thereof, the fasteners being slidably received in the grooves.

5. The computer system as claimed in claim 1, wherein the cover comprises two tabs formed on two opposite sides and adjacent to an end of the cover, the two tabs being pivotably attached to the enclosure.

6. The computer system as claimed in claim 5, wherein the cover comprises a tongue formed from an opposite end thereof, the enclosure defining a recess neighboring the window to receive the tongue of the cover.

7. The computer system as claimed in claim 1, wherein the two rails are fixed to the cover via a bracket.

8. The computer system as claimed in claim 7, wherein the bracket has a thickness large enough to prevent resonance during operation of the electronic component.

9. The computer system as claimed in claim 7, wherein the bracket defines a plurality of orifices arranged in matrix.

10. The computer system as claimed in claim 7, wherein the bracket comprises a plurality of flanges to confine the two rails on the bracket.

11. The computer system as claimed in claim 7, wherein the bracket is located between the electronic component and the cover.

12. The computer system as claimed in claim 1, wherein the electronic component is a hard disk.

13. A computer system comprising:
an enclosure defining a window;
a cover pivotably attached to the enclosure;
a pair of rails fixed respect to the cover; and
an electronic component slidably supported by the pair of rails;
wherein the cover is pivotable to an opened position where the electronic component is brought to expose out of the enclosure from the window, and the cover is pivotable to a closed position where the electronic component is covered by the cover within the enclosure.

14. The computer system as claimed in claim 13, wherein the electronic component has a plurality of screws fixed in two opposite sides thereof, the screws being slidable retained within the pair of rails, respectively.

15. The computer system as claimed in claim 13, wherein a bracket is located between the cover and the electronic component, the pair of rails being directly fixed to the bracket.

16. The computer system as claimed in claim 15, wherein the bracket comprises a plurality of flanges corresponding to the pair of rails, each of the pair of rails being surrounded by corresponding flanges.
